(19) United States
(12) Patent Application Publication
(10) Pub. No.: US 2013/0052869 A1
(43) Pub. Date: Feb. 28, 2013

(54) USB CONNECTOR

(71) Applicant: JUN-WEI WANG, Shenzhen City (CN)

(72) Inventor: JUN-WEI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/280,351

(22) Filed: Oct. 25, 2011

(30) Foreign Application Priority Data
Aug. 31, 2011 (CN) 201110254649.2

(51) Int. Cl. H01R 13/66; H01R 24/00

(52) U.S. Cl. 439/620.09; 439/660; 439/620.22

(57) ABSTRACT

A universal serial bus (USB) connector includes a housing and a main body received in the housing. The main body includes an insulator, a number of conductive terminals, a number of conductive pieces, and an anti-electromagnetic radiation (EMR) member. The conductive terminals, the conductive pieces, and the anti-EMR member are arranged in the insulator. Each conductive piece connects a corresponding one of the conductive terminals to the anti-EMR member.

### BACKGROUND

1. Technical Field

The present disclosure relates to a universal serial bus (USB) connector.

2. Description of Related Art

USB connectors are popular in many electronic devices. However, when the USB connectors are connected to the electronic devices, interference signals coming from the outside of the electronic devices may enter the electronic devices through the USB connectors, which will influence the normal operation of the electronic devices.

### BRIEF DESCRIPTION OF THE DRAWINGS

Many aspects of the present embodiments can be better understood with reference to the following drawings. The components in the drawing are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of an exemplary embodiment of a universal serial bus (USB) connector.

FIG. 2 is an isometric view of the assembled device of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

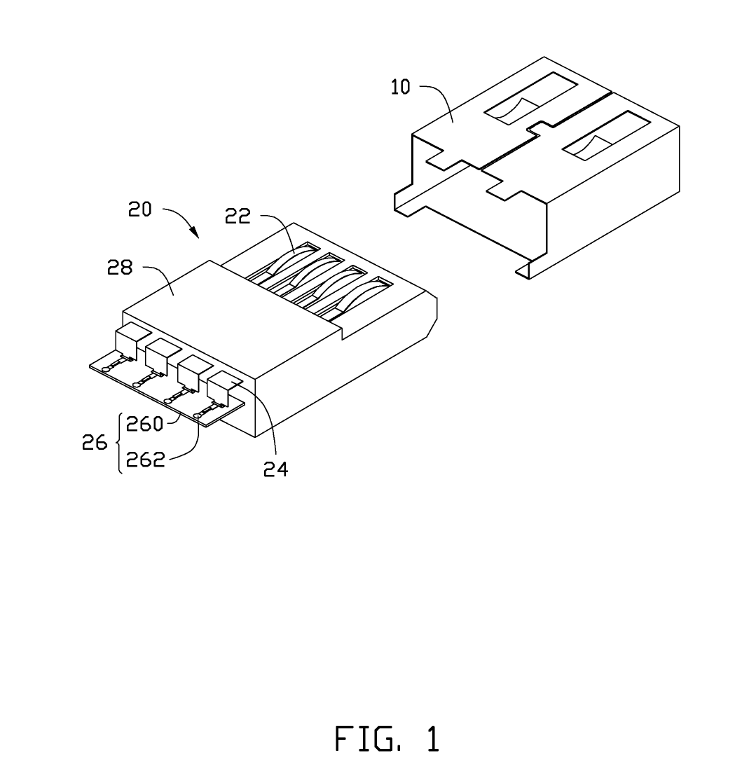

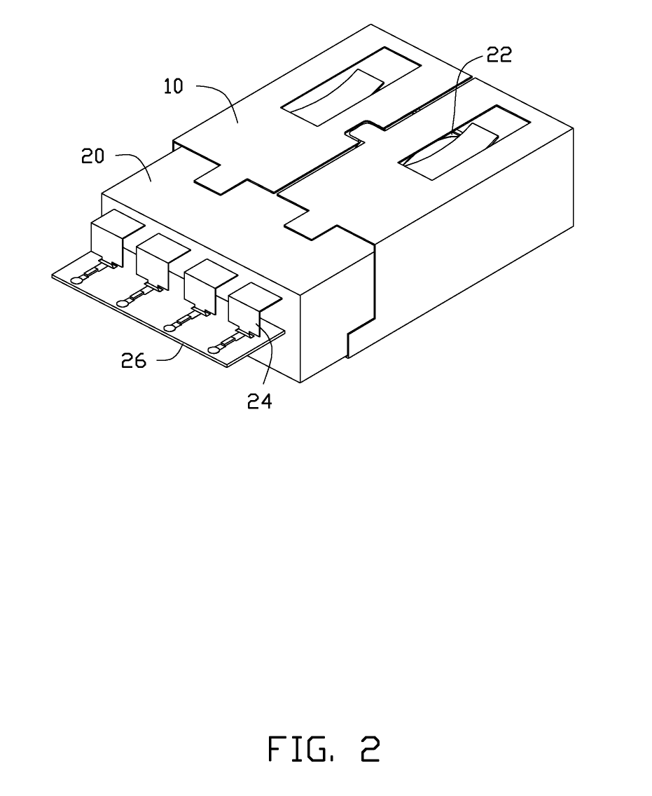

Referring to FIG. 1 and FIG. 2, an embodiment of a universal serial bus (USB) connector includes a housing 10 and a main body 20 received in the housing 10.

The main body 20 includes an insulator 28, a plurality of conductive terminals 22, a plurality of conductive pieces 24 electrically connected to the conductive terminals 22, and an anti-electromagnetic radiation (anti-EMR) member 26. The conductive terminals 22, the conductive pieces 24, and the anti-EMR member 26 are arranged in the insulator 28.

The anti-EMR member 26 includes a circuit board 260 and a plurality of anti-EMR components 262 set on the circuit board 260. The anti-EMR components 262 may be filters, capacitors, varistors, or lightning protection elements.

Each conductive piece 24 is substantially L-shaped. Each conductive piece 24 connects a conductive terminal 22 to the circuit board 260. Each anti-EMR component 262 connects a conductive piece 24 to a cable of the USB connector (not shown in figures).

The anti-EMR components 262 absorb any electromagnetic radiation which enters the USB connector.

Even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A universal serial bus (USB) connector, comprising:
a housing; and
a main body received in the housing, the main body comprising an insulator, a plurality of conductive terminals, a plurality of conductive pieces, and an anti-electromagnetic radiation (EMR) member, wherein the conductive terminals, the conductive pieces, and the anti-EMR member are arranged in the insulator, each of the conductive pieces connects a corresponding one of the conductive terminals to the anti-EMR member.

2. The USB connector of claim 1, wherein the anti-EMR member comprises a circuit board and a plurality of anti-EMR components set on the circuit board.

3. The USB connector of claim 2, wherein each anti-EMR component is a filter.

4. The USB connector of claim 2, wherein each anti-EMR component is a capacitor.

5. The USB connector of claim 2, wherein each anti-EMR component is a varistor.

6. The USB connector of claim 2, wherein each of the conductive pieces is substantially L-shaped, and connects the corresponding conductive terminal to the circuit board.
